(19) United States
(12) Patent Application Publication
(10) Pub. No.: US 2016/0052252 A1
(43) Pub. Date: Feb. 25, 2016

(54) PEELING PROCESS OF SUBSTRATE

(71) Applicant: E Ink Holdings Inc., Hsinchu (TW)

(72) Inventors: TA-NIEN LUAN, Hsinchu (TW); CHI-MING WU, Hsinchu (TW); MING-SHENG CHIANG, Hsinchu (TW); WEN-CHANG LU, Hsinchu (TW)

(21) Appl. No.: 14/883,623

(22) Filed: Oct. 15, 2015

Related U.S. Application Data
(63) Continuation of application No. 13/603,535, filed on Sep. 5, 2012.

(30) Foreign Application Priority Data
Jan. 11, 2012 (TW) 101101063

(51) Int. Cl. B32B 43/00; B32B 38/10

(52) U.S. Cl. CPC B32B 43/006; B32B 38/10

(57) ABSTRACT

A peeling process of substrate used for peeling a first substrate and a second substrate bonded to each other is provided. The first substrate has a first bonding surface, and the second substrate has a second bonding surface and a back surface, wherein the first bonding surface and the second bonding surface are bonded to each other. In the peeling process of substrate, a light beam is incident through the back surface of the second substrate at a first incident angle and illuminates the first bonding surface and the second bonding surface, wherein the first incident angle is smaller than 90 degree and larger than 0 degree. Thereafter, the second substrate is peeled off from the first substrate.

### CROSS-REFERENCE TO RELATED APPLICATION

This application is a continuation of U.S. application Ser. No. 13/603535, entitled “PEELING PROCESS OF SUBSTRATE”, by LUAN et al., tiled on Sep. 5, 2012, from which priority under 35 §121 is claimed, and the contents of which are fully incorporated, herein by reference.

### FIELD OF THE INVENTION

The present invention relates to a peeling process of substrate, and more particularly to the illumination steps of the peeling process of substrate.

### BACKGROUND OF THE INVENTION

Manufacturing display devices with flexible substrates replacing rigid substrates is a development trend of the next-generation display devices. Whether a fiat panel display is flexible depends on the material of the substrate. When a rigid, substrate is used in the flat panel display device, the fiat panel display device is not flexible. Conversely, when a flexible substrate, such as a plastic substrate, is used in the flat panel display device, the flat panel display device is flexible. At present, technologies of forming thin film transistors on a rigid substrate are becoming mature, but technologies of forming thin film transistors on a flexible substrate are yet to be developed.

For demands of using flexible substrates into process, rigid substrates are used for supporting flexible substrates in the present processes so that the cost of manufacturing process can be reduced. In general, the flexible substrate is usually bonded on the rigid substrate firstly, and then a series of film-forming processes are performed to form films on the flexible substrate. At last, the flexible substrate is separated from the rigid substrate by using laser separation process to remove the rigid substrate.

However, during the film-forming process, rigid substrates used for supporting flexible substrates have to be transported constantly between various process equipments, so that some damages, such as serapes, detects or impurities adhesive, may be resulted on the back surface of the rigid substrate during the course of transportation. Accordingly, in the following laser separation process, since the laser light is emitted into the rigid substrate through the back surface, the scrapes, defects or impurities will reduce the energy of the laser beam penetrating the rigid substrate, so that the flexible substrate cannot be successfully detached from the rigid substrate.

Furthermore, flexible substrates may suffer pressures during some processes proceeded thereon, so that the adhesion between the rigid substrate and the parts of the flexible substrate suffering pressures is greater than that between the rigid substrate and the parts of the flexible substrate not suffering pressures. Accordingly, parts of the flexible substrate cannot separate completely from the rigid, substrate after being illuminated by the laser beam.

Since the flexible substrate is not completely separated from the rigid substrate, the components formed on the flexible substrate will be damaged by forcibly peeling the flexible substrate from the rigid, substrate and the process yield will be decreased.

### SUMMARY OF THE INVENTION

In view of the above problems, the present invention provides a peeling process of substrate for separating two substrates bonded to each other without damaging elements formed thereon.

A peeling process of substrate suitable for separating a first substrate and a second substrate bonded to each other is provided in an embodiment of the present invention. The first substrate has a first bonding surface. The second substrate has a second bonding surface and a back surface opposite to each other, and the first bonding surface is bonded to the second bonding surface. The peeling process of substrate includes the following steps. First, a light beam is provided for illuminating the first bonding surface and the second bonding surface by being incident through the back surface of the second substrate at a first incident angle, wherein the first incident angle is larger than 0 degree and smaller than 90 degree. Thereafter, the second substrate is peeled from the first substrate.

In the peeling process of substrate of two substrates of the present invention, the light obliquely illuminates the bonding surface between the substrates at least two times, so that the light can be incident into the substrates by dodging the scrapes, defects or impurities adhesive on the surface of the substrates. Therefore, the energy of the light can be efficiently transmitted to the bonding surface between the substrates for facilitating the peeling process of the substrates.

For making the above and other purposes, features and benefits become more readily apparent to those ordinarily skilled in the art, the preferred embodiments and the detailed descriptions with accompanying drawings will be put forward in the following descriptions.

### BRIEF DESCRIPTION OF THE DRAWINGS

FIG. 1A and FIG. 1B are schematic diagrams of a peeling process of two substrates of an embodiment of the present invention.

FIG. 2 is a schematic diagram of two substrates illuminated by light in the peeling process of substrate of another embodiment of the present invention.

FIG. 3 is a schematic diagram of two substrates illuminated by light in the peeling process of substrate of another embodiment of the present invention.

FIG. 4 is a schematic diagram of two substrates illuminated by light in the peeling process of substrate of another embodiment of the present invention.

FIG. 5 is a schematic diagram of two substrates illuminated by light in the peeling process of substrate of another embodiment of the present invention.

FIG. 6 is a schematic diagram of two substrates illuminated by light in the peeling process of substrate of another embodiment of the present invention.

### DETAILED DESCRIPTION OF PREFERRED EMBODIMENTS

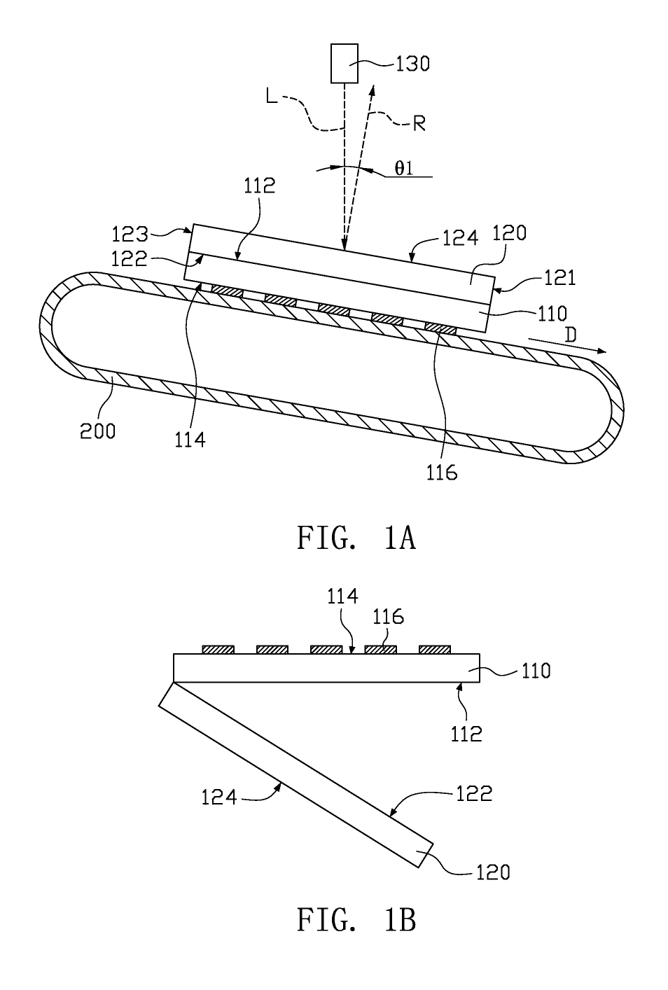

FIG. 1A and FIG. 1B are schematic diagrams of the peeling process of two substrates of an embodiment of the present invention. Referring to FIG. 1A and FIG. 1B, a first substrate 110 has a first bonding surface 112 and an element configuration surface 114 and a second substrate 120 has a second bonding surface 122 and a back surface 124 opposite to each other. The first bonding surface 112 and the second bonding surface 122 are bonded to each other. Specifically, the second substrate 120 may be a hard substrate, such as a glass substrate. The first substrate 110 may be a flexible substrate, such as a plastic substrate formed with polymers. In addition, a plurality of elements 116 are, for example, formed on the element configuration surface 114 of the first substrate 110. In details, these elements are, for example, scan lines, date lines, thin film transistors and pixel electrodes. In other words, the elements formed on the first substrate 110 may be but not limited to active element arrays used for driving a display panel.

During the peeling process of substrate of the present invention, a light beam L is incident through the back surface 124 of the second substrate 120 at a first incident angle to illuminate the first bonding surface 112 and the second bonding surface 122. Moreover, the first incident angle θ1 is greater than 0 degree and less than 90 degree. In the present embodiment, the first incident angle θ1 is, for example, but not limited to, greater than or equal to 5 degrees.

For example, the light beam L is provided by a fixed light source 130, such as a laser light source. That is, the light beam L emitted from the light source 130 is a laser beam. Furthermore, the first substrate 110 and the second substrate 120 bonded to each other are, for example, placed on a conveyer belt 200 and the back surface 124 of the second substrate 120 is upward and parallel to a moving direction D of the conveyer belt 200. The light source 130 is fixed upon the conveyer belt 200 and emits the light beam L along a direction perpendicular to the horizontal. The conveyer belt 200 is, for example, oblique at an angle with respect to the horizontal, so that a normal direction R of the back surface 124 of the second substrate 120 placed thereon is oblique at the first incident angle θ1 with respect to the light beam L. Accordingly, the light beam L is incident through the back surface 124 of the second substrate 120 at the first incident angle θ1.

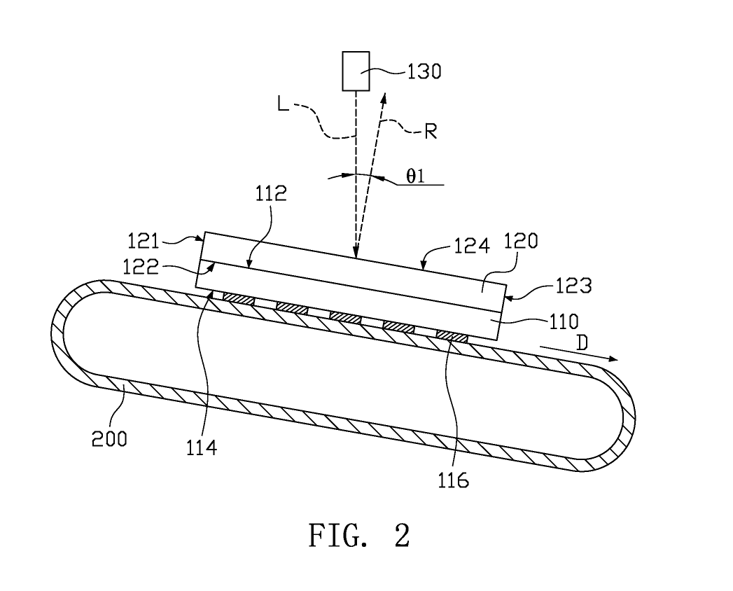

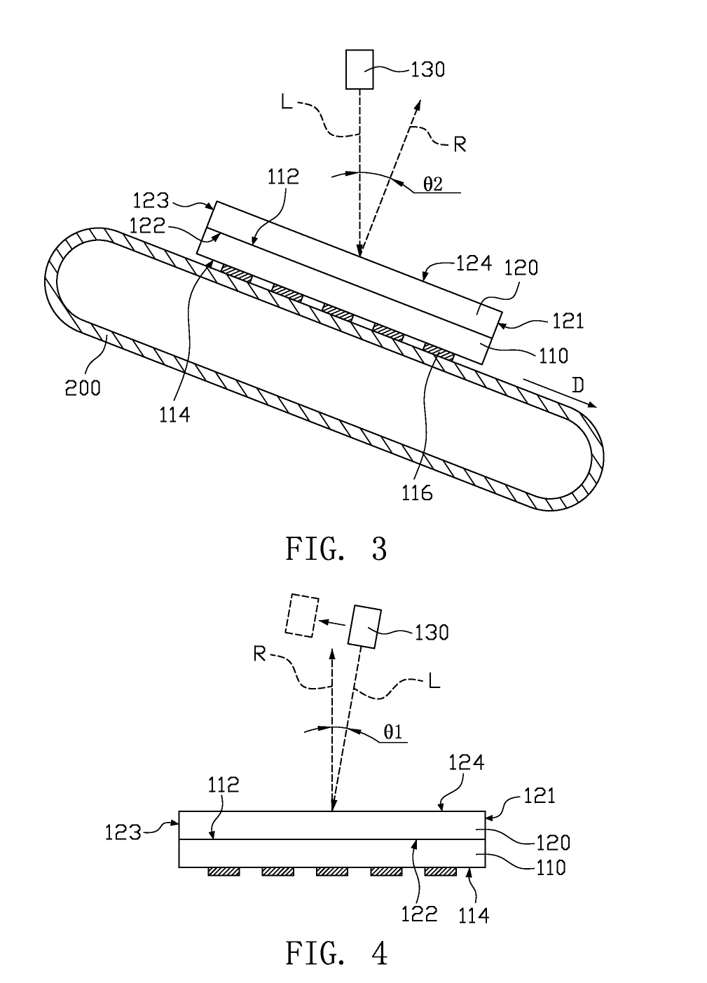

Thereafter, as shown in FIG. 1B, the first substrate 110 is peeled from the second substrate 120. In particular, in order to ensure that the energy of the light beam transmitted to the first bonding surface 112 and the second bonding surface 122 is enough to completely peel the first substrate 110 from the second substrate 120, the light beam F emitted from the light source 130 illuminates the first bonding surface 112 and the second bonding surface 122 along different directions at least two times in the present embodiment. Moreover, in these illumination processes, the light beam L may be incident through the back surface 124 of the second substrate 120 at different incident angles As shown in FIG. 1A, the second substrate has a first side 121 and a second side 123 opposite to each other, and during the illumination process in the embodiment, the first side 121 of the second substrate 120 is in front of the second side 123 when the first substrate 110 and the second substrate 120 are moved along the moving direction D. Thereafter, as shown in FIG. 2, the first substrate 110 and the second substrate 120 also can be turned, and then the first substrate 110 and the second substrate 120 are moved along the moving direction D to be illuminated by the light beam F again. In the movement, the second side 123 is in front of the first side 121. Alternatively, as shown in FIG. 3, the first substrate 110 and the second substrate 120 can be rotated at first, and then the first substrate 110 and the second substrate 120 are moved, therefore the light beam F can be incident through any point of the back surface 124 of the second substrate 120 at a second incident angle θ2 different from the first incident angle θ1. As a result, since the light beam L obliquely illuminates through the back 124 of the second substrate 120 several times, the light beam L can be incident into the first bonding surface 112 and the second bonding surface 122 without being blocked by the scrapes or impurities on the back surface 124 of the second substrate 120. Therefore the energy of the light beam L can be effectively transmitted to the first bonding surface 112 and the second bonding surface 122 and thereby the first substrate 110 can be completely peeled off from the second substrate 120.

It should be noted that although the first substrate 110 and the second substrate 120 are moved relative to the light source 130 by the conveyer belt 200, the present invention is not limited hereto. In other embodiments, the first substrate 110 and the second substrate, 120 may also be moved relative to the light source 130 by other means. Furthermore, the first substrate 110 and the second substrate 120 also can be fixed and. the light source 130 moves relative to the first substrate 110 and the second substrate 120 during the illumination process. The following will give embodiments to make a detailed description.

FIG. 4 is a schematic diagram of partial peeling process of two substrates in another embodiment of the present invention. Referring to FIG. 4, the first substrate 110 and the second substrate 120 are fixed firstly. Further, the back surface 124 of the second substrate 120 faces to the light source 130 adjacent thereto. Then, the light source 130 is moved from the first side 121 towards the second side 123. In the movement, the light beam L is incident at the first incident angle θ1 through the back surface 124 at any point.

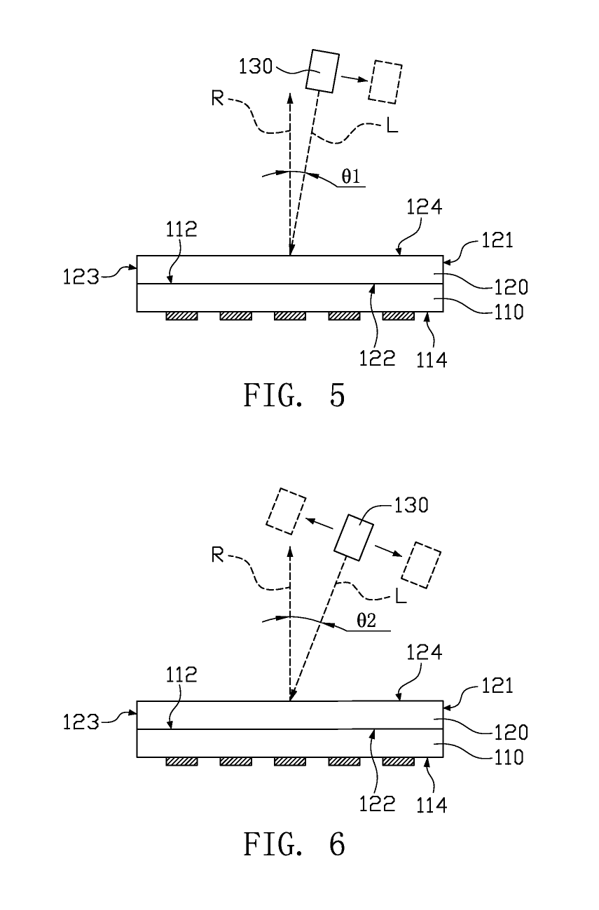

As shown in FIG. 5, after the light source 130 is moved from the first side 121 towards the second side 123, the light source 130 can also be moved from the second side 123 to the first side 121, therefore the light beam L is reversely incident through the second substrate 120.

Furthermore, the first substrate 110 and the second substrate 120 may be rotated so as to let the light beam L be incident through the back surface 124 of the second substrate 120 at the second incident angle θ2 different from the first incident angle θ1, as shown in FIG. 6. In the illumination process, as shown in FIG. 6, the light source 130 may be moved from the first side 121 towards the second side 123, or be moved from the second. side 123 towards the first side 121.

In summary in the peeling process of two substrates of the present invention, the light obliquely illuminates the bonding surface between the two substrates at least two times. Therefore, even when there are scrapes, defects or impurities attached to the surface of the substrate, the light can still illuminate the bonding surface between the two substrates without being blocked thereby. In this way, the energy provided by the light can be effectively transmitted to the bonding surface between the two substrates, and one substrate can be easily peel off from the other substrate, so as to improve the process yield.

While the invention has been described in terms of what is presently considered to be the most practical and preferred embodiments, it is to be understood that the invention needs not be limited to the disclosed embodiment. On the contrary, it is intended to cover Various modifications and similar arrangements included within the spirit and scope of the appended claims which are to be accorded with the broadest interpretation, so as to encompass all such modifications and similar structures.

What is claimed is:

1. A process of peeling a substrate suitable for separating a first substrate and a second substrate bonded to the first substrate, wherein the first substrate has a first bonding surface, the second substrate has a second bonding surface and a back surface opposite to the second bonding surface, the first bonding surface is bonded to the second bonding surface, the peeling process comprising:
providing a fixed light source for emitting a tight beam illuminating the first bonding surface and the second bonding surface b being incident through the back surface of the second substrate at a first incident angle;
maintaining the first incident angle of the fixed light source illuminating the first bonding surface and the second bonding surface constant at different positions at different times; and
peeling off the second substrate from the first substrate.

2. The process of peeling a substrate according to claim 1, wherein the light beam comprises a laser beam.

3. The process of peeling a substrate according to claim 1, wherein the step of providing a fixed light source for emitting a light beam illuminating the first bonding surface and the second bonding surface by being incident through the back surface of the second substrate at a first incident angle further comprises:
tilting the second substrate to make an angle between a normal direction of the back surface of the second substrate and the light beam equal to the first incident angle; and
moving the first substrate and the second substrate bonded with the first substrate along a moving direction parallel to the back surface of the second substrate.

4. The process of peeling a substrate according to claim 3, wherein the second substrate has a first side and a second side opposite to the first side, and the first side is in front of the second side in the moving direction.

5. The process of peeling a substrate according to claim 4, wherein the step of providing a fixed light source for emitting a light beam illuminating the first bonding surface and the second bonding surface by being incident through the back surface of the second substrate at a first incident angle further comprises:
turning the first substrate and second substrate bonded to the first substrate to position the second side in front of the first side in the moving direction; and
moving the first substrate and the second substrate bonded to the first substrate along the moving direction.

6. The process of peeling a substrate according to claim 1, wherein the first incident angle is larger than or equal to 5 degrees.

7. The process of peeling a substrate according to claim 1, wherein before peeling the first substrate from the second substrate, the step further comprises providing the light beam incident through the back surface of the second substrate at a second incident angle different from the first incident angle.

8. The process of peeling a substrate according to claim 4, wherein the light source is moved from the second side to the first side after the light source is moved from the first side towards the second side, the light beam of the fixed light source is reversely incident through the second substrate.

9. The process of peeling a substrate according to claim 1, wherein the first incident angle is larger than 0 degree and smaller than 90 degree.

10. A process of peeling a substrate suitable for separating a first substrate and a second substrate bonded to the first substrate, wherein the first substrate has a first bonding surface, the second substrate has a second bonding surface and a back surface opposite to the second bonding surface, and the second substrate has a first side and a second side opposite to the first side, the first bonding surface is bonded to the second bonding surface, the peeling process comprising:
providing a light source for emitting a light beam illuminating the first bonding surface and the second bonding surface by being incident through the back surface of the second substrate at a first incident angle;
moving the light source from the first side towards the second side;
maintaining the first incident angle of the light beam illuminating the first bonding surface and the second bonding surface constant at different positions at different times; and
peeling off the second substrate from the first substrate.

11. The process of peeling a substrate according to claim 10, wherein the light beam comprises a laser beam.

12. The process of peeling a substrate according to claim 10, wherein the step of providing a light source for emitting a light beam illuminating the first bonding surface and the second bonding surface by being incident through the back surface of the second substrate at a first incident angle further comprises:
providing a moveable light source adjacent to the back surface of the second substrate for emitting the light beam; and
moving the moveable light source from the first side of the second substrate to the second side of the second substrate, wherein the first side and the second side are respectively extended towards opposite edges of the back surface of the second substrate.

13. The process of peeling a substrate according to claim 12, wherein the step of providing a light source for emitting a light beam illuminating the first bonding surface and the second bonding surface by being incident through the back surface of the second substrate at a first incident angle further comprises moving the light source from the second side towards the first side.

14. The process of peeling a substrate according to claim 12, wherein after moving the light source from the first side towards the second side, the step further comprises:
moving the light source suitable tar emitting the light beam to make a second incident angle between a normal direction of the back surface of the second substrate and the light beam, wherein the second incident angle is different from the first incident angle; and
moving the light source from the second side towards the first side.

15. The process of peeling a substrate according to claim 10, wherein the first incident angle is larger than or equal to 5 degrees.

16. The process of peeling a substrate according to claim 10, wherein before peeling off the second substrate from the first substrate, the step further comprises providing the light beam incident through the back surface of the second substrate at a second incident angle different from the first incident angle.

17. the process of peeling a substrate according to churn 10, wherein the light source is moved from the second side to the first side after the light source is moved from the first side towards the second side, the light beam of the light source is reversely incident through the second substrate.

18. The process of peeling a substrate according to claim 10, wherein the first incident angle is larger than 0 degree and smaller than 90 degree.
